(19) United States
(12) Patent Application Publication
(10) Pub. No.: US 2007/0038432 A1
(43) Pub. Date: Feb. 15, 2007

(54) Data acquisition and simulation architecture

(76) Inventor: Maurice De Grandmont, St-Joseph-Du-Lac (CA)

Correspondence Address: LOWE HAUPTMAN BERNER, LLP, 1700 DIAGONAL ROAD, SUITE 300, ALEXANDRIA, VA, 22314, US

(21) Appl. No.: 11/503,911

(22) Filed: Aug. 15, 2006

Related U.S. Application Data
(60) Provisional application No. 60/707,981, filed on Aug. 15, 2005.

(51) Int. Cl. G06F 9/45

(52) U.S. Cl. 703/22

(57) ABSTRACT

A system and method of communicating data acquisition and simulation signals are described. The system includes a plurality of networked nodes. Each node is connected to the other nodes using a reflective memory connection. The nodes include an input/output node configured to communicate test signals and a simulation node configured to receive signals from the input/output node and to generate simulation signals. The method includes communicating an acquired data signal from an input/output node to a simulation node using a reflective memory-based communication network and communicating a generated simulation signal from the simulation node to the input/output node using the reflective memory-based communication network.

### RELATED APPLICATIONS

The present application claims priority to prior U.S. Provisional Patent Application 60/707,981 entitled, “Data Acquisition & Simulation Architecture” filed on Aug. 15, 2005 and incorporated by reference herein in its entirety.

### FIELD

The disclosed embodiments relate to a data acquisition and simulation architecture.

### BACKGROUND

Data acquisition architectures provide the ability to capture data from systems and store the data for later analysis. The analysis of the data enables users to refine designs for the systems tested.

Simulation architectures provide the ability to generate data usable by users to generate designs for systems prior to the systems being constructed and tested.

### SUMMARY

The present embodiments provide a data acquisition and simulation architecture.

A system embodiment for data acquisition and simulation includes a plurality of networked nodes. Each node is connected to the other nodes using a reflective memory connection. The networked nodes include an input/output node configured to communicate test signals and a simulation node configured to receive signals from the input/output node and to generate simulation signals.

A method embodiment includes communicating an acquired data signal from an input/output node to a simulation node using a reflective memory-based communication network and communicating a generated simulation signal from the simulation node to the input/ouput node using the reflective memory-based communication network.

Still other advantages of the embodiments will become readily apparent to those skilled in the art from the following detailed description, wherein the preferred embodiments are shown and described, simply by way of illustration of the best mode contemplated of carrying out the invention. As will be realized, the invention is capable of other and different embodiments, and its several details are capable of modifications in various obvious respects, all without departing from the embodiments.

### DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a high level functional block diagram of an embodiment;

FIG. 2 is a high level functional block diagram of an input/output node of the FIG. 1 embodiment;

FIG. 3 is a high level conceptual diagram of components of an embodiment;

FIG. 4 is a process flow diagram of an embodiment; and

FIG. 5 is a high level functional block diagram of a computer system usable in conjunction with an embodiment.

### DETAILED DESCRIPTION

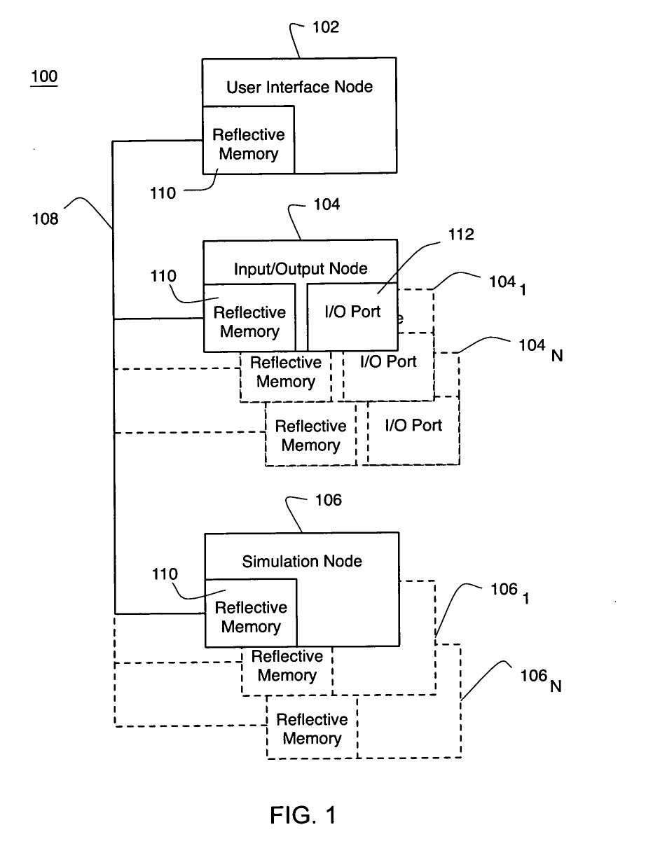

FIG. 1 depicts a data acquisition and simulation architecture 100 according to an embodiment in which several interconnected nodes communicate using a communication network. Specifically, the nodes includes a user interface node 102, an input/output (I/O) node 104, and a simulation node 106 each connected with a reflective memory-based communication network 108. Each node 102, 104, 106 includes a reflective memory network interface 110 to connect the node to the communication network 108. Communication network 108 includes a mechanism for providing two-way data communication, e.g., the communication network may be a wired or wireless communication network. Electrical, electromagnetic, or optical signals may be transmitted over communication network 108 and carry digital data streams representing various types of information. For example with respect to FIG. 1, communication network 108 enables communication of signals including: acquired data from I/O node 104 to be transmitted to simulation node 106 and user interface node 102; simulated command signals from simulation node 106 to be transmitted to I/O node 104; and captured and simulated data from I/O node 104 and simulation node 106 to be transmitted to user interface node 102. In other embodiments, different signals and routing of signals between nodes may be employed.

FIG. 1 depicts additional (optional) I/O nodes 104₁-104_{N} and simulation nodes 106₁-106_{N}. In alternate embodiments, architecture 100 may include one or more additional nodes, as dictated by the specifics of the particular architecture. Additionally, additional user interface nodes 102 may be employed, though not shown in FIG. 1.

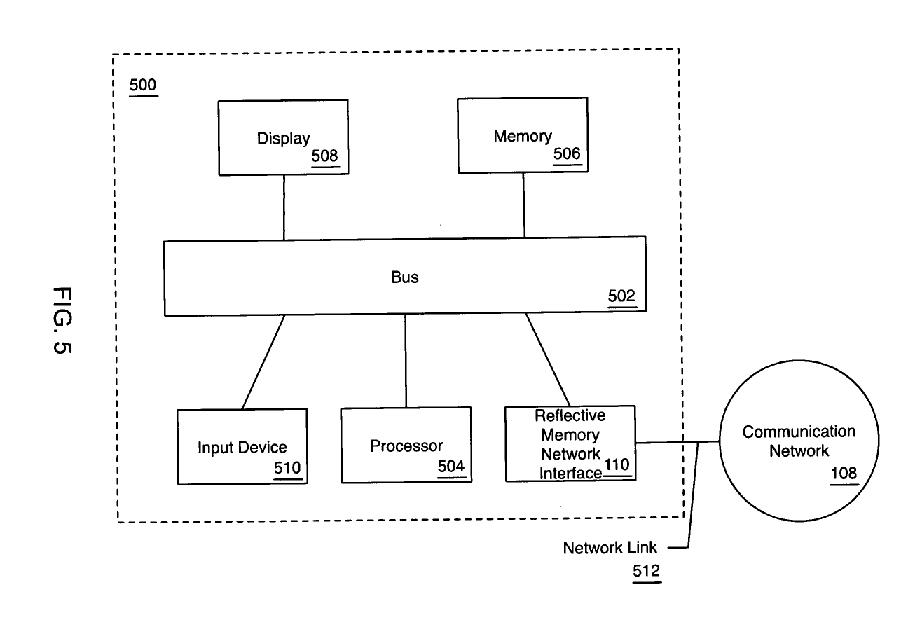

User interface node 102 is a computer system as described below in detail in conjunction with FIG. 5 and is configured to display a user interface to a user via a display, e.g., display 508 (FIG. 5). The user interface displayed to the user provides system control, monitoring, and graphical applications, e.g., graphing capabilities, to users of user interface node 102. User interface also controls sharing of common data base with other nodes including configuration information such as variables, etc. Additionally, user interface node 102 includes development platform software tools for developing, distributing, and coordinating executable software on other nodes.

As described above, user interface node 102 includes a reflective memory network interface 110 connecting the user interface node to the communication network 108 and thereby to I/O node 104 and simulation node 106.

I/O node 104 is a computer system as described below in detail in conjunction with FIG. 5; however, in an embodiment, the I/O node may not include a display 508 or an input device 510 (FIG. 5). I/O node 104 includes executable software enabling the transfer in real-time of data signals, e.g., measurements, received from an I/O port 112 to the reflective memory network interface 110 and therethrough to the other nodes 102, 106 via network 108. I/O node 104 uses a real-time clock signal transmitted over network 108 in order to synchronize data transfer and executable software execution, as necessary.

I/O node 104 receives input signals from and transmits output signals to a unit under test and/or an integrated system test rig (ISTR) via I/O port 112. The input and output signals communicated by the I/O port 112 may be analog, discrete, or a combination of signals. In an embodiment, a UUT may be a rudder or control surface of an airframe providing analog signals to the I/O port 112 responsive to movement by a user, in the case of a rudder, or another device, in the case of a control surface.

In at least some embodiments, I/O node 104 may be an input node or an output node, in addition to being a combined input/output node.

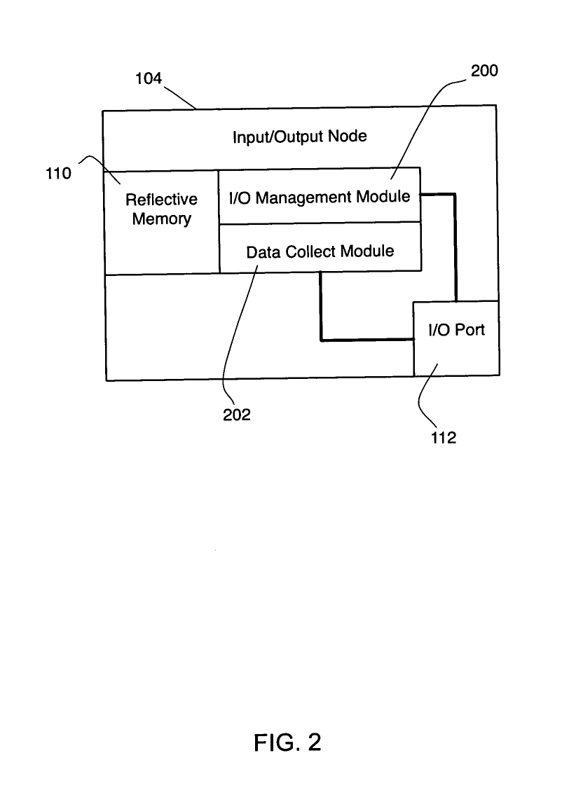

FIG. 2 depicts a functional block diagram of components of I/O node 104. In particular, I/O node 104 includes above-noted reflective memory network interface 110 and I/O port 112. Additionally, I/O 104 node includes an I/O management module 200 for transferring in real time data signals from an input device connected with I/O port 112 to reflective memory network interface 110 and transferring output data from the reflective memory network interface to the output device connected with the I/O port. I/O node 104 further includes a data collect module 202 for transferring in real time data signals from reflective memory network interface 110 to a local storage device.

In another embodiment, in place of a single I/O node 104 including both I/O management module 200 and data collect module 202, architecture 100 includes an I/O node 104 including an I/O management module 200 and another I/O node 104 including a data collect module 202. In a further embodiment, there may be multiple I/O nodes each of which comprise a data collect module 202.

In embodiments having more than a single I/O node 104, each I/O node may use a different type of computer system technology, as appropriate. For example, node 104 may use VXI, VME, and/or desktop, industrial rack mount, and/or laptop computer system. The particular technology used may vary depending on the device connected with I/O port 112.

Returning now to FIG. 1, simulation node 106 is a computer system similar to the above described I/O node 104 in that the simulation node may not include a display 508 or an input device 510 (FIG. 5). Simulation node 106 includes executable software enabling the transfer in real time of data signals generated by simulation software executed by the simulation node to I/O node 104 using reflective memory network interface 110. Additionally, data signals received via I/O port 112 of I/O node 104 are received by simulation node 106 via reflective memory network interfaces 110 of the respective nodes connected by network 108. In this manner, simulation node 106 executing simulation software transfers simulated output data signals to a device under test connected with I/O port 112 and receives input data signals from device under test connected with the I/O port. Thus, real time simulation software executable executing by simulation node 106 receives and is able to respond to real time data signals received from a device connected with I/O node 104.

Reflective memory-based communication network 108 communication links connecting reflective memory network interfaces 110 in each of nodes 102, 104, 106. Communication network 108 in conjunction with reflective memory network interface 110 provides a distributed multiple node shared memory system which has high speed, low latency communications for the connected nodes 102, 104, 106. In at least some embodiments, the configuration of communication network 108 may be a ring or star shaped or other configuration. In operation, executable software executing on a node performs a write to a local memory address at which the reflective memory network interface 110 exists. The network interface 110 transmits the written data to all connected network interfaces 110 at the other nodes connected with the communication network 108. In this manner, each node 102, 104, 106 includes a copy of the written data in local memory. In particular, a specific executing software executable need not be aware that data written to the specified memory address is being distributed to other network interfaces 110 nor does the software executable need to be aware that data read from a specified memory address is received from another network interface.

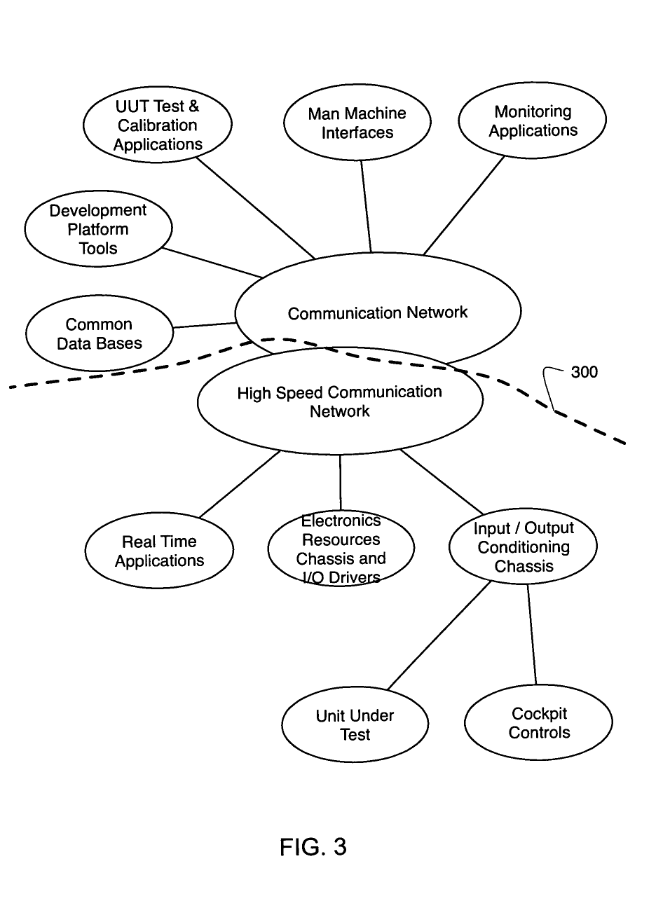

FIG. 3 depicts a high level conceptual diagram of functionality associated with an architecture 100 of an embodiment. Elements above separator line 300 (dash dot line) include non-real time elements while elements below the separator line include elements communicating in real time over communication network 108. In at least some embodiments, the non-real time elements include software and/or hardware elements communicating via a communication network. In at least some embodiments, the communication network over which the non-real time elements communicate is separate from communication network 108. The common data base elements, under control of the user interface, communicate with elements from both sides of the separator line. In at least some embodiments, the common data base elements communicate via a connection between communication network and the high speed communication network.

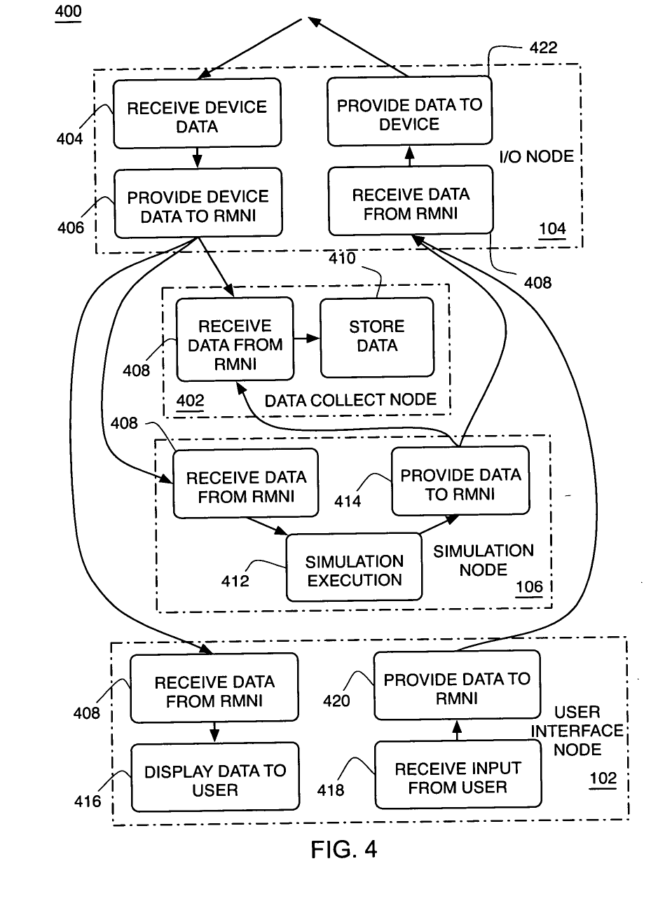

FIG. 4 is a non-limiting example process flow 400 diagram of an embodiment in operation. The FIG. 4 example includes transfer of data between a device, e.g., a unit under test, connected to I/O node 104, between the I/O node and a data collect node 402, simulation node 106, and user interface node 102. As depicted in this embodiment, data collect node 402 is separate from I/O node 104 in contrast with I/O node 104 of FIG. 2. Further, in an embodiment, I/O node 104 includes additional functionality related to conditioning the data signals communicated with the connected device, e.g., analog to digital conversions, etc.

A device, connected with I/O node 104 via I/O port 112, transmits data signals, e.g., analog, digital, etc., to the I/O node. I/O node 104 executing instructions comprising process step 404 receives the data from the device. The process flow proceeds to step 406 wherein I/O node 104 provides the device data to reflective memory network interface 110. In an embodiment, I/O node 104 writes the device data to one or more predetermined memory addresses which correspond to designated addressable portions of the network interface 110. I/O node 104 providing the device data to network interface 110 causes the distribution of the device data to each of data collect node 402, simulation node 106, and user interface node 102. Each receiving node 402, 106, 102 includes a process step 408 which when executed causes the node to receive data from the respective network interface 110. As described above, each reflective memory network interface 110 is connected with communication network 108.

Turning now to data collect node 402, the data collect node is similar to I/O node 104 of FIG. 1 without including the I/O management module 200. Data collect node 402 receives data from the network interface 110 at step 408 and the process flow proceeds to step 410 wherein the data collect node stores the received data. In this embodiment, data collect node 402 acts as a data storage repository for data transmitted over network 108. In alternative embodiments, data collect node 402 may be configured to receive and store select types of data.

Turning now to simulation node 106, the simulation node receives data from the network interface 110 at step 408 and the process flow proceeds to step 412 wherein the simulation node causes execution of a software executable comprising a simulation responsive to the received data. In an embodiment, simulation node 106 is executing a simulation and receives the data as additional input to the simulation execution. The process flow proceeds to step 414 upon receipt of simulation output from step 412. At step 414, simulation node 106 provides the output data to the reflective memory network interface 110 and therethrough to I/O node 104, as described below.

In another embodiment, simulation node 106 executes a simulation and receives input data from I/O node 104 and provides output data to the I/O node during execution of the simulation. In this manner, the simulation is able to receive real time data from a device connected with I/O node 104 and provide the results of a real time simulation execution as output back to the device responsive to the input real time data.

Turning now to user interface node 102, the user interface node receives data from the network interface 110 at step 408 and the process flow proceeds to step 416 wherein the user interface node executes a software executable to display the received data to a user at the user interface node. For example, the user may view a graphic depicting motion of a device, or other parameters.

Process step 418 receives user input at user interface node 102, e.g., input device 510 manipulation, and the process flow proceeds to step 420. At step 420, user interface node 102 provides the user data to the reflective memory network interface 110 and therethrough to I/O node 104.

As describe above with respect to process step 408 and nodes 402, 106, 102, I/O node 104 at step 408 receives data from the network interface 110 and the process flow proceeds to step 422 wherein the I/O node provides the received data to the connected device (not shown).

FIG. 5 is a block diagram illustrating an exemplary computer system 500 upon which an embodiment may be implemented. Computer system 500 includes a bus 502 or other communication mechanism for communicating information, and a processor 504 communicatively coupled with bus 502 for processing information. Computer system 500 also includes a memory 506, such as a random access memory (RAM) or other dynamic storage device, communicatively coupled to the bus 502 for storing instructions to be executed by processor 504. Memory 506 also may be used for storing temporary variables or other intermediate information during execution of instructions to be executed by processor 504.

Computer system 500 is coupled via bus 502 to display 508, such as a liquid crystal display (LCD) or other display technology, for displaying information to the user. Input device 510 is communicatively coupled to bus 502 for communicating information and command selections to the processor 504.

According to one embodiment, computer system 500 operates in response to processor 504 executing sequences of instructions contained in memory 506 and responsive to input received via input device 510, or communication interface 512. Such instructions may be read into memory 506 from a computer-readable medium or reflective memory network interface 110.

Execution of the sequences of instructions contained in memory 506 causes the processor 504 to perform the functionality described above. In alternative embodiments, hard-wired circuitry may be used in place of or in combination with computer software instructions to implement the embodiments. Thus, embodiments are not limited to any specific combination of hardware circuitry and software.

Computer system 500 also includes a reflective memory network interface 110 coupled to the bus 502. Reflective memory network interface 110 provides two-way data communication. For example, network interface 110 may be a communication link. In any such implementation, network interface 110 sends and receives electrical, electromagnetic or optical signals which carry digital data streams representing various types of information. Of particular note, the communications through network interface 110 may permit transmission or receipt of data signals for use by nodes 102, 104, 106.

Network link 512 typically provides data communication through one or more networks to other devices. For example, network link 512 may provide a connection through communication network 108 to nodes 102, 104, 106 (as depicted in FIG. 1). The signals through the various networks and the signals on network link 512 and through network interface 110, which carry the digital data to and from computer system 500, are exemplary forms of carrier waves transporting the information.

Computer system 500 can send messages and receive data, including program code, through the network(s), network link 512 and network interface 110. Received code may be executed by processor 504 as it is received, and/or stored in memory 506 for later execution. In this manner, computer system 500 may obtain application code in the form of a carrier wave.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A system for data acquisition and simulation, comprising:
a plurality of networked nodes, wherein each node is connected to the other nodes using a reflective memory connection, comprising:
an input/output node configured to communicate test signals; and
a simulation node configured to receive signals from the input/output node and to generate simulation signals.

2. A system as in claim 1, wherein the plurality of networked nodes further comprises:
a user interface node configured to display a user interface to a user and to receive a command from the user.

3. A system as in claim 1, wherein the reflective memory connection includes a real-time communication protocol for communication between each of the nodes.

4. A system as in claim 1, wherein each of the input/output node and the simulation node include real-time operating systems.

5. A system as in claim 1, wherein a real-time clock signal is used to synchronize transfers between the networked nodes.

6. A system as in claim 1, wherein the networked nodes further comprise:
one or more additional input/output nodes.

7. A system as in claim 1, wherein the networked nodes further comprise:
one or more additional simulation nodes.

8. A system as in claim 1, wherein the input/output node comprises:
an input/output port for connection with one of a unit under test and a test rig.

9. A system as in claim 8, wherein the input/output node comprises:
a data collection module for receiving one or more signals from the input/output port.

10. A system as in claim 8, wherein the input/output port is configured to receive signals from one of a unit under test and a test rig and to transmit signals to one of a unit under test and a test rig;
wherein the input/output node transmits input/output port received signals to the simulation node using the reflective memory connection.

11. A system as in claim 8, wherein the simulation node transmits simulation signals to the input/output node using the reflective memory connection; and
wherein the input/output node transmits simulation signals to one of a unit under test and a test rig.

12. A system as in claim 2, wherein the user interface node is configured to assign memory locations in the reflective memory connection of each networked node, the memory locations specifying input and/or output locations for each node.

13. A method of communicating data acquisition and simulation signals, comprising:
communicating an acquired data signal from an input/output node to a simulation node using a reflective memory-based communication network; and
communicating a generated simulation signal from the simulation node to the input/output node using the reflective memory-based communication network.

14. A method as claimed in claim 13, further comprising:
communicating the acquired data signal from the input/output node to a data collect node using a reflective memory-based communication network.

15. A method as claimed in claim 13, further comprising:
communicating the generated simulation signal from the simulation node to a data collect node using a reflective memory-based communication network.

16. A method as claimed in claim 13, further comprising:
communicating the acquired data signal from the input/output node to a user interface node using a reflective memory-based communication network.

17. A method as claimed in claim 13, further comprising:
communicating the generated simulation signal from the simulation node to a user interface node using a reflective memory-based communication network.

18. A method as claimed in claim 13, further comprising:
specifying memory locations in a reflective memory connection of each of the input/output node and simulation node, the memory locations specifying input and/or output locations for each node.

19. A memory or a computer-readable medium storing instructions which, when executed by a processor, cause the processor to perform the method of claim 13.
